(19) United States
(12) Patent Application Publication
(10) Pub. No.: US 2025/0259358 A1
(43) Pub. Date: Aug. 14, 2025

(54) IMAGE PROCESSING APPARATUS AND METHOD, AND STORAGE MEDIUM

(71) Applicant: CANON KABUSHIKI KAISHA, Tokyo (JP)

(72) Inventors: Kuya NISHIZUMI, Kanagawa (JP); Takuma YANAGISAWA, Tokyo (JP)

(21) Appl. No.: 19/192,797

(22) Filed: Apr. 29, 2025

Related U.S. Application Data
(63) Continuation of application No. PCT/JP2023/035349, filed on Sep. 28, 2023.

(30) Foreign Application Priority Data
Nov. 15, 2022 (JP) 2022-182795

(51) Int. Cl. G06T 11/60; H04N 23/63; H04N 23/80

(52) U.S. Cl. CPC G06T 11/60; H04N 23/632; H04N 23/80

(57) ABSTRACT

An image processing apparatus comprises: an image acquisition unit that acquires a first image; a degree-of-fluctuation acquisition unit that acquires a degree of fluctuation of a fluctuation element among elements constituting the first image; a generation unit that uses the first image to generate a second image in which the degree of fluctuation of the fluctuation element is different from the first image with use of a trained learning model; and a display control unit that controls to display an image. If the first image and the second image diverge by a predetermined divergence or more, the generation unit further uses the first image to generate a third image in which the degree of fluctuation of the fluctuation element is less than the second image, and the display control unit controls to display the first image and to thereafter display the third image.

### CROSS-REFERENCE TO RELATED APPLICATIONS

This application is a Continuation of International Patent Application No. PCT/JP2023/035349, filed Sep. 28, 2023, which claims the benefit of Japanese Patent Application No. 2022-182795, filed Nov. 15, 2022, both of which are hereby incorporated by reference herein in their entirety.

### BACKGROUND OF THE INVENTION

### Field of the Invention

The present invention relates to an image processing apparatus and method, and a storage medium.

### Background Art

In recent years, new technologies relating to image processing using AI technologies and advanced computational processing have been proposed as technologies related to image generation. This includes much research into technologies relating to generation of non-existent images using Generative Adversarial Networks (GANs), which are a type of unsupervised learning, as well as many related presentations of papers and proposals for inventions. Under such a background, it has become possible for an image obtained through shooting (hereinafter, “shot image”) to be manipulated using image processing technologies represented by GANs and reconstructed to reflect the intention of the user who shot the image.

On the other hand, recent image capturing devices including digital cameras and smartphones are generally provided with a display unit for displaying images. In a normal shooting action, a live view image is displayed at the time of shooting, and, after development of the shot image is completed, the user is able to switch to preview display of the shot image that has been developed (hereinafter, “recorded image”) and visually confirm whether the recorded image is as the user intended.

Similarly, when a recorded image is reconstructed to generate a new image, the user is able to visually confirm whether the image obtained through reconstruction (hereinafter, “reconstructed image”) is as the user intended, by previewing the reconstructed image on a display unit. However, depending on the shooting scene, there may be a large divergence between the recorded image and the reconstructed image, and when the reconstructed image is generated and previewed immediately after shooting, the user may feel a strong sense of incongruity due to the difference from the scene before the user's eyes or confirmation may take time.

Examples of divergence between the live view image and the recorded image include the case where a difference between images occurs as a result of the shooting timing and the recording timing deviating due to shutter release time lag or the like. In response, PTL 1 discloses a technology according to which a live view image is displayed or an image obtained by performing smoothing filter processing on the recorded image is displayed before previewing the recorded image, in order to reduce the sense of incongruity felt at the time of preview display caused by the timing deviation between shooting and recording.

Also, PTL 2 discloses generating and sequentially displaying a plurality of manipulated images in which the composition ratio of the next recorded image to be displayed is gradually increased with respect to the recorded image currently being displayed, when sequentially displaying a plurality of recorded images shot with a single shooting instruction. The sense of incongruity of switching to preview display of recorded images can thereby be reduced.

However, there is a problem in that, when displaying a reconstructed image, the images before and after reconstruction may differ greatly and thus display of manipulated images by the methods disclosed in PTL 1 and PTL 2 alone is not enough to reduce sense of incongruity felt at the time of preview display.

The present invention has been made in view of the above issues, and an object of the invention is to, in the case of generating reconstructed images, reduce the sense of incongruity felt at the time of preview display of the reconstructed images.

### CITATION LIST

### Patent Literature

PTL 1 Japanese Patent Laid-Open No. 2005-204210
PTL 2 Japanese Patent Laid-Open No. 2014-127966

### SUMMARY OF THE INVENTION

In order to achieve the above object, an image processing apparatus of the present invention includes one or more processors and/or circuitry which function as an image acquisition unit that acquires a first image, a degree-of-fluctuation acquisition unit that acquires a degree of fluctuation of a fluctuation element having fluctuation which is variation in a state, among elements constituting the first image, a generation unit that uses the first image to generate a second image in which the degree of fluctuation of the fluctuation element is different from the first image with use of a trained learning model, and a display control unit that controls to display an image on a display device, in which, in a case where the first image and the second image diverge by greater than or equal to a predetermined divergence, the generation unit further uses the first image to generate a third image in which the degree of fluctuation of the fluctuation element is less than the second image, and the display control unit performs control to display the first image and to thereafter display the third image.

Further features of the present invention will become apparent from the following description of exemplary embodiments with reference to the attached drawings.

### BRIEF DESCRIPTION OF THE DRAWINGS

FIG. 1A is a block diagram showing an example functional configuration of an image processing apparatus according to an embodiment of the present invention.

FIG. 1B is a block diagram showing an example hardware configuration of the image processing apparatus according to the embodiment.

FIG. 2 is a diagram illustrating fluctuation of elements constituting images according to the embodiment.

FIG. 3 is a flowchart showing fluctuation model training processing according to the embodiment.

FIG. 4 is a flowchart showing image reconstruction processing according to the embodiment.

FIG. 5A is a diagram showing an example of image fluctuation rule generation according to the embodiment.

FIG. 5B is a diagram showing an example of image fluctuation rule generation according to the embodiment.

FIG. 5C is a diagram showing an example of image fluctuation rule generation according to the embodiment.

FIG. 5D is a diagram showing an example of image fluctuation rule generation according to an embodiment.

FIG. 6 is a diagram showing an example of image generation according to the embodiment.

FIG. 7 is a flowchart showing operations of image generation and display processing according to a first embodiment.

FIG. 8 is a diagram showing the flow of image generation processing according to the first embodiment.

FIG. 9 is a diagram showing example image generation according to the first embodiment.

FIG. 10A is a diagram showing the flow of different image generation processing according to the first embodiment.

FIG. 10B is a diagram showing the flow of different image generation processing according to the first embodiment.

FIG. 11 is a flowchart showing operations of image generation and display processing according to a second embodiment.

FIG. 12 is a diagram showing example image generation according to the second embodiment.

FIG. 13 is a flowchart showing operations of image generation and display processing according to a third embodiment.

FIG. 14 is a diagram showing the flow of image generation processing according to the third embodiment.

FIG. 15 is a diagram showing example image generation according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

Hereinafter, description will be given using a digital camera capable of generating images, as an example of an image processing apparatus according to a first embodiment. Note that the present embodiment is not limited to a digital camera and can also be applied to other devices capable of generating images. Examples of these devices include mobile phones such as smartphones, game consoles, personal computers, tablet terminals, wearable information terminals, server devices, and the like.

### Example Configuration of Digital Camera

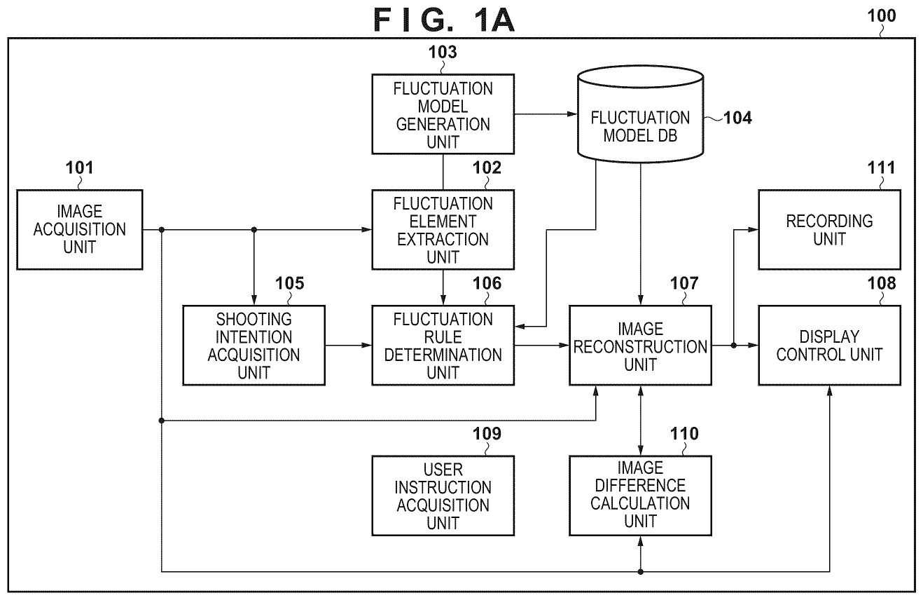

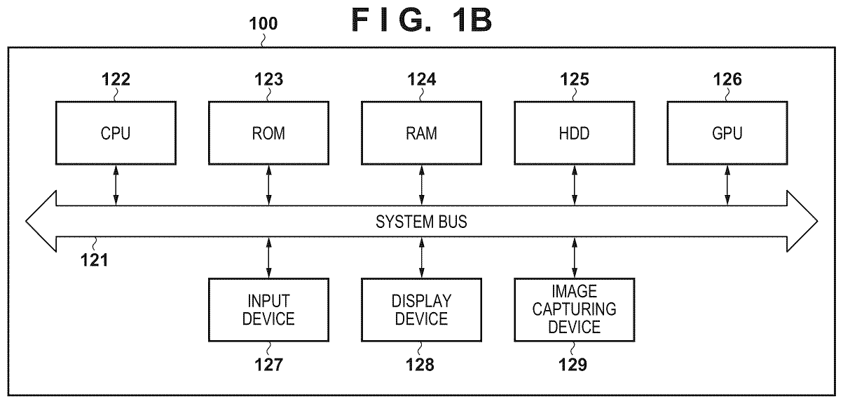

FIG. 1A is a diagram showing an example functional configuration of a digital camera 100 as an example of an image processing apparatus in the embodiment, and FIG. 1B is a diagram showing an example hardware configuration of the digital camera shown in FIG. 1A. Some or all of the functional configuration of the digital camera 100 shown in FIG. 1A can be realized by, for example, a CPU 122 or a GPU 126 shown in FIG. 1B executing a computer program.

As shown in FIG. 1A, the digital camera 100 includes an image acquisition unit 101, a fluctuation element extraction unit 102, a fluctuation model generation unit 103, a fluctuation model database 104, and a shooting intention acquisition unit 105. Furthermore, the digital camera 100 includes a fluctuation rule determination unit 106, an image reconstruction unit 107, a display control unit 108, a user instruction acquisition unit 109, an image difference calculation unit 110, and a recording unit 111.

Also, as shown in FIG. 1B, the hardware configuration of the digital camera 100 includes a system bus 121, the CPU 122, a ROM 123, a RAM 124, an HDD 125, the GPU 126, an input device 127, a display device 128, and an image capturing device 129. These components is connected to the system bus 121.

The CPU 122 is a computational circuit such as a CPU (central processing unit), and realizes the functions of the digital camera 100, by extracting a computer program stored in the ROM 123 or the HDD 125 to the RAM 124 and executing the computer program. The ROM 123 includes, for example, a non-volatile storage medium such as a semiconductor memory, and stores programs that are executed by the CPU 122 and required data. The RAM 124 includes a volatile storage medium such as a semiconductor memory, for example, and temporarily stores computation results of the CPU 122, for example.

The HDD 125 includes a hard disk drive, and stores computer programs that are executed by the CPU 122, processing results thereof, and the like, for example. Furthermore, the HDD 125 (recording medium) stores images recorded by the recording unit 111. Note that, in this example, the digital camera 100 is described as having a hard disk, but the digital camera 100 may have a storage medium such as an SSD instead of a hard disk.

The GPU (Graphics Processing Unit) 126 includes a computational circuit and can, for example, execute some or all of processing of the learning model training stage and processing of the inference stage. Since a GPU is able to parallel process more data than a CPU, performing processing with a GPU is effective in deep learning processing in which repetitive operations using neural networks are performed.

The input device 127 includes operation members such as buttons and a touch panel that receive operation inputs to the digital camera 100. The display device 128 includes a display panel such as an OLED, for example. The image capturing device 129 includes optical system units such as a lens, a diaphragm, and a shutter, and an image sensor such as a CMOS sensor, for example. The optical system units may also include a fly-eye lens or a multi-ocular lens. Also, the optical units may be capable of changing optical characteristics such as zoom and aperture, according to the image that is acquired, for example.

In the digital camera 100 having the above configuration, first, the image acquisition unit 101 performs image acquisition processing. Note that, in the present embodiment, the image acquisition unit 101 may acquire not only an image but also meta information for the image. Meta information for an image includes date-time information of when the image was acquired, and acquisition position information, for example. The image acquisition unit 101 controls acquisition of images by the image capturing device 129, and outputs acquired images to the fluctuation element extraction unit 102, the shooting intention acquisition unit 105, the image reconstruction unit 107, the display control unit 108, and the image difference calculation unit 110. Note that the image acquisition unit 101 may output acquired images after having normalized the images by performing optional image processing such as cropping or resizing thereon in accordance with the output destination.

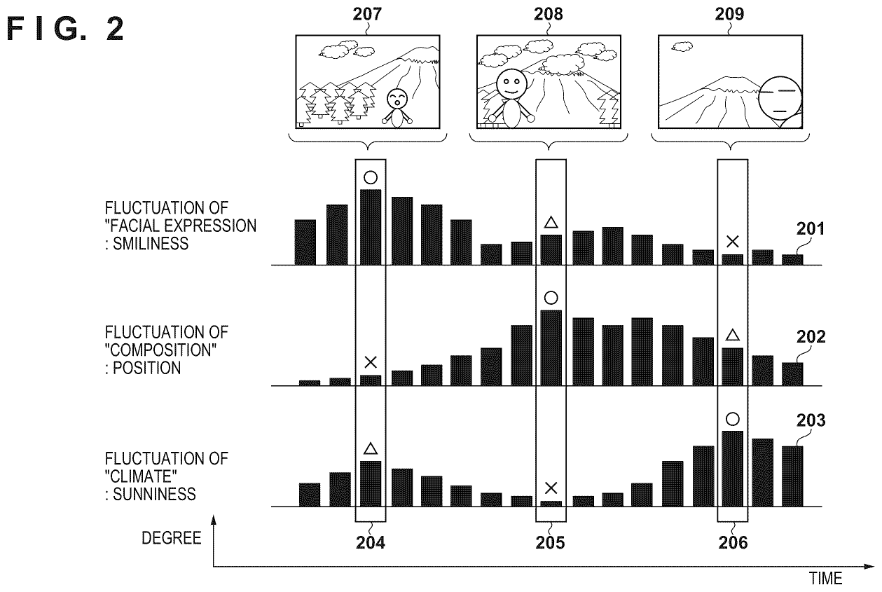

Here, “fluctuation” and “fluctuation element” according to the present embodiment will be described, with reference to FIG. 2.

FIG. 2 represents “fluctuation” of elements constituting images. In FIG. 2, the horizontal axis represents time, and the vertical axis represents the magnitude of the degree of each element. Bar graphs 201, 202, and 203 show changes over time of the elements constituting the images. For example, the bar graph 201 shows the change over time of “smiliness” out of “facial expressions” of a main subject. The bar graph 202 shows the change over time of “position” out of “compositions”, and the bar graph 203 shows the change over time of “sunniness” out of “climate”.

In the present embodiment, the variation in the state of the elements constituting an image is referred to as “fluctuation”. For example, variation (change) in the state of one element such as smiliness is described as “fluctuation”. Note that elements having “fluctuation” are called “fluctuation elements”. Also, “fluctuation”, that is, variation in the state thereof, can be detected by measuring the degree of the state in a plurality of acquired images.

Here, description will be given taking as an example the case where the user's intention for shooting an image (intention for acquiring image) is one of the “smiliness” of the “facial expression” being high, the subject appearing on the left side as the “position” of the “composition”, and the “sunniness” of the “climate” being high.

In the example shown in FIG. 2, the timing at which the fluctuation of each fluctuation element is closest to the shooting intention is a timing 204 at which the “smiliness” is highest, a timing 205 at which the “position” is highest (subject on left side), and a timing 206 at which the “sunniness” is highest. Also, the images acquired at the timings 204, 205, and 206 are given as images 207, 208, and 209, respectively.

Returning to the description of FIG. 1, the fluctuation element extraction unit 102 extracts a fluctuation element included in an image. For example, in an example where a person's facial expression is a fluctuation element, the fluctuation element extraction unit 102 executes detection of a person's face in an image and extracts the fluctuation element. Furthermore, when a person's face is detected, the fluctuation element extraction unit 102 performs processing for acquiring the degree of fluctuation in the person's expression. For example, the fluctuation element extraction unit 102 acquires this degree of fluctuation and quantifies the degree of smiliness, the degree of emotion, the degree of eye openness, the degree of mouth openness, and the like. Note that when acquiring the degree of fluctuation, the degree of fluctuation may be calculated from the image, or the degree of fluctuation corresponding to the image may be acquired via a network.

Also, other fluctuation elements may include the posture of a person in the image, the composition of the image, the lighting in the image, the climate in the image, and the clothing of the subject in the image, for example. The posture of the person includes at least one of the orientation of the face, the orientation of the body, and the amount of blurring of the person's movement, for example. Also, the composition of the image includes at least one of the positional relationship of subjects, and the distance between subjects, for example. The lighting in the image includes the position of the light source, for example. The climate in the image includes at least one of weather and cloudiness, for example. The clothing in the image includes at least one of the type and color of clothing, for example.

The fluctuation element extraction unit 102 outputs the calculated degree of fluctuation of the fluctuation element together with the image to the fluctuation rule determination unit 106. Also, the fluctuation element extraction unit 102 outputs the image and the degree of fluctuation of the fluctuation element to the fluctuation model generation unit 103 as learning data of a fluctuation model described later.

The fluctuation model generation unit 103 performs processing for training a learning model for each fluctuation element (hereinafter, “fluctuation model”), using the image and the degree of fluctuation of the extracted fluctuation element obtained from the fluctuation element extraction unit 102. The fluctuation model is generated for each fluctuation element and is trained to generate an image corresponding to a designated degree of fluctuation. For example, a fluctuation model whose fluctuation element is a person's facial expression is trained to generate an image of a designated facial expression. Note that even with the same fluctuation element, a plurality of fluctuation models may be generated for each period such as one month, for each area that the user went to, according to user instructions and the like.

Also, the fluctuation models may be generated using known machine learning algorithms capable of generating images, such as GANs, for example. GANs are constituted by two neural networks, namely, a generator that generates images and a discriminator that discriminates whether images generated by the generator are real images. In the processing of the training stage of the fluctuation model, the above-described generator and discriminator share a loss function with each other, and repeatedly update respective neural networks such that the generator minimizes and discriminator maximizes the loss function. Images generated by the generator thereby appear more natural. Note that since known technology is applied in relation to the learning algorithm and the configuration of the neural networks in the GANs, description thereof in the present embodiment is omitted.

In this way, the data used in training is saved to the fluctuation model database 104 in association with the trained fluctuation model. In other words, images included in the learning data and the degrees of the fluctuation elements of the images are held in the fluctuation model database 104 in association with information indicating the fluctuation elements (corresponding to the models).

The fluctuation model database 104 is stored in the HDD 125 and stores a fluctuation model for each fluctuation element generated by the fluctuation model generation unit 103 and the data used in training.

Note that, in the present embodiment, the fluctuation model generation unit 103 and the fluctuation model database 104 are described as being included in the digital camera 100. However, a configuration may be adopted in which a communication unit is provided in the digital camera 100, and the fluctuation model generation unit 103 and/or the fluctuation model database 104 are disposed on an external server or a cloud. Alternatively, the fluctuation model generation unit 103 and the fluctuation model database 104 may be disposed on both the digital camera 100 and an external server and selectively used depending on application or purpose.

For example, a database and a fluctuation model generation unit for generating fluctuation models that are associated with fluctuation elements whose use frequency is expected to be high such as the facial expression of the main subject are disposed in the digital camera 100. On the other hand, a fluctuation model generation unit for generating fluctuation models whose use frequency is low, in-training fluctuation models, and/or learning data may be stored in an external server. The update histories of the fluctuation models may also be managed on the external server or cloud service side.

The shooting intention acquisition unit 105 acquires, from an input image, the shooting intention that the user who shot the image wants to express, and outputs a shooting intention identifier indicating the shooting intention to the fluctuation rule determination unit 106.

In the present embodiment, for example, the relationship between fluctuation elements included in images and shooting intention identifiers is defined in advance, and fluctuation elements included in acquired images are converted to shooting intention identifiers. That is, the shooting intention acquisition unit 105 is able to acquire shooting intention identifiers based on the image information of images. The shooting intention identifiers include keywords such as those used in tagging with general images such as “fun” and “souvenir photo”, for example. Furthermore, the shooting intention acquisition unit 105 may receive an instruction or a selection regarding the shooting intention identifier from the user. Also, the shooting intention acquisition unit 105 may infer information of the shooting intention identifier from the operation history of operations performed for the purpose of image acquisition and the user behavior history such as the number of shooting attempts.

The shooting intention acquisition unit 105 may further output a shooting intention identifier using sound information. For example, the shooting intention acquisition unit 105 can also convert sound information of a shooting space including the voice of the user into a shooting intention identifier, by using ambient sound information at the time of shooting.

The fluctuation rule determination unit 106 calculates, with respect to the fluctuation element of the image that the user wants to reconstruct and the degree thereof, the amount of change in the degree of fluctuation for each fluctuation element (hereinafter, “fluctuation rule”), using the shooting intention identifier. Also, the fluctuation rule determination unit 106 designates the fluctuation model to be used by the image reconstruction unit 107 described later. Note that processing by the fluctuation rule determination unit 106 will be described in detail later.

The image reconstruction unit 107 reads out a fluctuation model from the fluctuation model database 104, in accordance with the fluctuation rule determined by the fluctuation rule determination unit 106. The image reconstruction unit 107 then performs image reconstruction, by inputting the image that the user wants to reconstruct and parameters for use in reconstruction to the fluctuation model. Note that the image reconstruction unit 107 is not limited to generating one image and can generate and output a plurality of images with different degrees of change of the fluctuation element. Note that image reconstruction will be described in detail later. The image reconstruction unit 107 outputs the reconstructed image to the display control unit 108.

The display control unit 108 causes the display device 128 to display various images. In the present embodiment, the display control unit 108 causes the display device 128 to at least display the image acquired by the image acquisition unit 101 or the image reconstructed by the image reconstruction unit 107.

The user instruction acquisition unit 109 receives various instructions relating to reconstruction of the image from the user, via the input device 127, and prompts the processing units of the digital camera 100 to perform predetermined processing. For example, the user instruction acquisition unit 109 receives image acquisition instructions and reconstruction instructions from the user. The user instruction acquisition unit 109 may additionally receive designation of a shooting intention identifier and parameters required in image reconstruction, such as a fluctuation model.

The image difference calculation unit 110 calculates the difference between the two input images and determines the degree of divergence between the two images. Note that the image calculation method will be described in detail later.

The recording unit 111 records images to the HDD 125. Note that, in the present embodiment, the case where a recording device that records images is included in the digital camera 100 is described as an example, but a communication unit may be provided in the digital camera 100 and images may be recorded on an external server or a cloud.

### Training Processing of Fluctuation Model

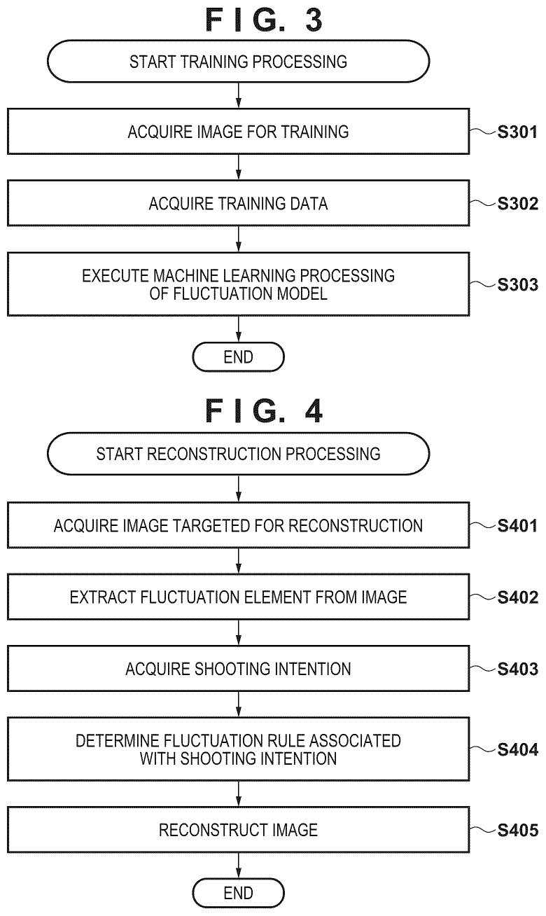

Next, training processing of the fluctuation model by the fluctuation model generation unit 103 and the like will be described with reference to FIG. 3. Note that this processing can, for example, be realized by the CPU 122 or GPU 126 of the digital camera 100 executing a computer program, and can be realized by the various units shown in FIG. 1A. Also, this processing can basically be executed at the timing at which a shooting instruction is received from the user and in an arbitrary period including that timing. The present invention is, however, not limited thereto, and, even if a shooting instruction is not received from the user, shooting may be executed at regular intervals, in the case where, for example, the image acquisition unit 101 is operating and the user is capable of shooting an image of his or her surrounding environment.

When the training processing is started, first, in step S301, the image acquisition unit 101 controls the image capturing device 129 to acquire an image for training. The acquired image for training is, for example, a still image. Also, the image acquisition unit 101 may shoot a moving image and take still images from the moving image. Note that the acquired image is not limited to that output by the image capturing device 129, and an image acquired in advance and stored in the HDD 125 may be used. Also, the image for training may be limited to an image acquired in a specific period or at a specific position. For example, the image for training may be an image acquired in the period between predetermined start and end instructions by the user, as a shooting period or a learning data collection period. Alternatively, the image for training may be acquired according to the image targeted for reconstruction. Furthermore, the image for training may be an image acquired during a predetermined period including the acquisition date-time of the image targeted for reconstruction processing. Alternatively, the image for training may be an image acquired in a predetermined range around the acquisition position of the image targeted for reconstruction processing.

The image acquisition unit 101 outputs the image data of the acquired still image to the fluctuation element extraction unit 102.

Next, in step S302, the fluctuation element extraction unit 102 extracts a predetermined fluctuation element from the image data of the still image that is input, and calculates (acquires) the degree of fluctuation (score) for the extracted fluctuation element. Also, the fluctuation element extraction unit 102 normalizes the calculated degree of fluctuation in the region including the extracted fluctuation element from the image data of the still image that is input and outputs the normalized degree of fluctuation to the fluctuation model generation unit 103 as learning data of the fluctuation model, together with degree-of-fluctuation information.

Note that, in this description, it is assumed that this processing is executed, for each fluctuation element, on the image data of each still image. However, the extraction frequency of the fluctuation elements may be determined for each fluctuation element. For example, elements whose fluctuation changes drastically may be extracted at a higher frequency, and elements whose fluctuation changes gradually may be extracted at a lower frequency.

In step S303, the fluctuation model generation unit 103 reads out information of the fluctuation model targeted for training from the fluctuation model database 104, and performs machine learning processing of the fluctuation model, using the input learning data. The machine learning processing of the fluctuation model is, for example, processing of the training stage of GANs described above. Thereafter, the fluctuation model generation unit 103 updates the fluctuation model information in the fluctuation model database 104 together with the data used in learning. Note that if a fluctuation model targeted for training does not exist in the fluctuation model database 104, a fluctuation model is newly added.

The above processing uses the fluctuation of fluctuation elements in images acquired by the user as learning data for each fluctuation element model. The neural network of the generator of GANs capable of tuning the fluctuation of fluctuation elements (i.e., capable of generating images that correspond to a designated degree of fluctuation) can thereby be constructed.

### Reconstruction Processing

Next, image reconstruction processing that uses a fluctuation model will be described, with reference to FIG. 4. Note that this processing can, for example, be realized by the CPU 122 or GPU 126 of the digital camera 100 executing a computer program and can be realized by the various units shown in FIG. 1A. Note that this processing is started in response to receiving an instruction from the user. At the start of the processing, one image targeted for reconstruction may be selected, and the instruction may be given at any suitable timing. Note that, here, the processing is started in response to receiving an image acquisition instruction as the instruction from the user, and, in addition, a reconstruction instruction may be received during display of a recorded image after image acquisition or may be received at the time of image playback.

When the image reconstruction processing is started, the image acquisition unit 101, in step S401, acquires an image that is targeted for reconstruction. Note that, as a specific example of the following description, the case where an image 208 shown in FIG. 2 is the image targeted for reconstruction will be described.

Next, in step S402, the fluctuation element extraction unit 102 receives the image targeted for reconstruction from the image acquisition unit 101, extracts a fluctuation element included in the image, and calculates (acquires) the degree of fluctuation of the fluctuation element. The operations of the fluctuation element extraction unit 102 performed here are similar to the processing in the training processing performed in step S302 of FIG. 3.

In step S403, the shooting intention acquisition unit 105 acquires a shooting intention identifier from an arbitrary information group attached to the image. For example, a shooting intention identifier such as “travel”, “commemorative photo”, or “fun” is acquired from the person who appears in the image 208, his or her facial expression, or a background object, and associated with the image.

Note that the shooting intention acquisition unit 105 may acquire a shooting intention identifier, based on further information other than the image. For example, when the digital camera 100 is equipped with a voice recognition technology, the shooting intention acquisition unit 105 utilizes the result of voice recognition in acquiring a shooting intention identifier. For example, the shooting intention acquisition unit 105 may acquire a shooting intention identifier, based on utterance information of the user recorded during a predetermined period including the date-time that the image was shot, or utterance information of the user input during a predetermined period after the image is played back. Specifically, when the user is recognized as saying something like “it's clouded over”, “it's too cloudy to see”, or “I wish it was sunny” at the time of acquiring the image 208 or at the time of instructing reconstruction, “climate” or “sunniness”, which is considered the ideal state, may be used as a keyword. In this case, the keyword is associated with the image as the shooting intention identifier.

In addition to the above-described examples, a configuration may be adopted in which the shooting intention identifier is calculated through prediction from the user's operation history information or behavior history information, text information input by the user, and the like during a period including the time of the shooting action of the image 208 selected in step S401.

Thereafter, the shooting intention acquisition unit 105 outputs the shooting intention identifier to the fluctuation rule determination unit 106 with the image 208 associated therewith.

In step S404, the fluctuation rule determination unit 106 determines a fluctuation rule that will serve as control information for the image reconstruction unit 107, using the image targeted for reconstruction, the fluctuation element information associated with the image, and the shooting intention identifier.

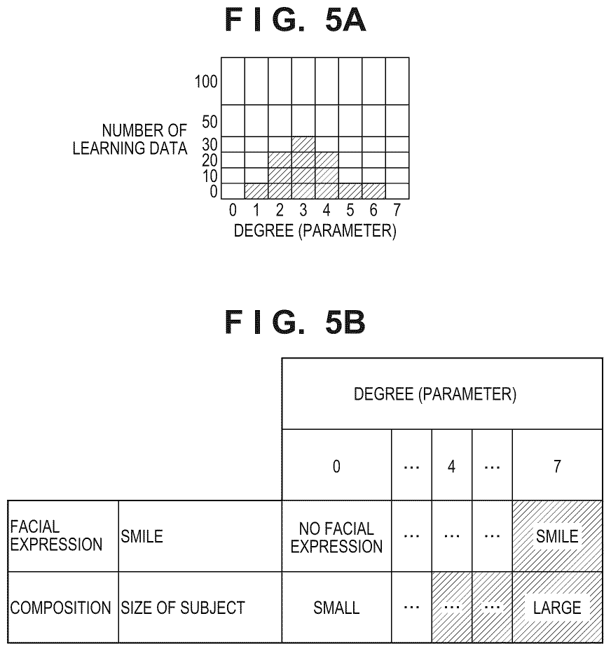

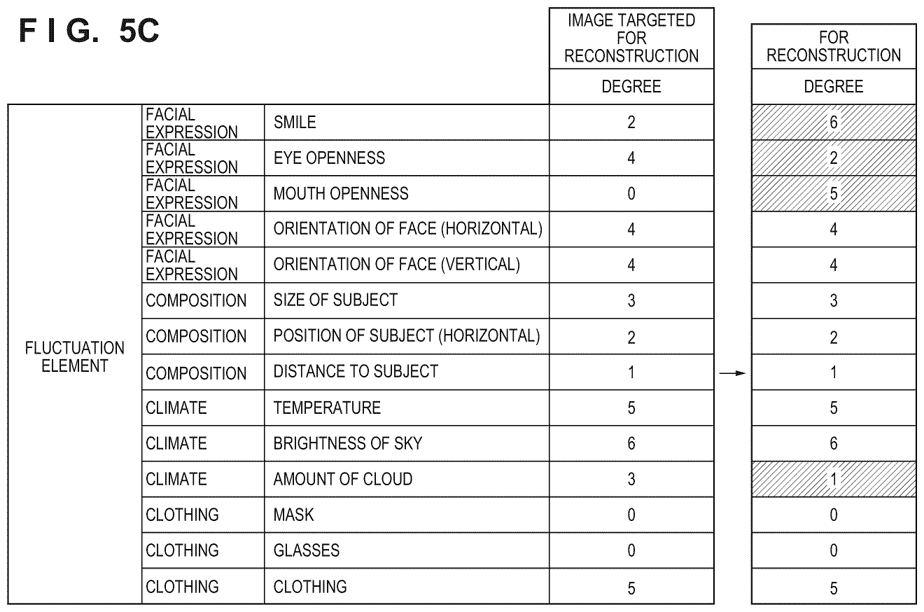

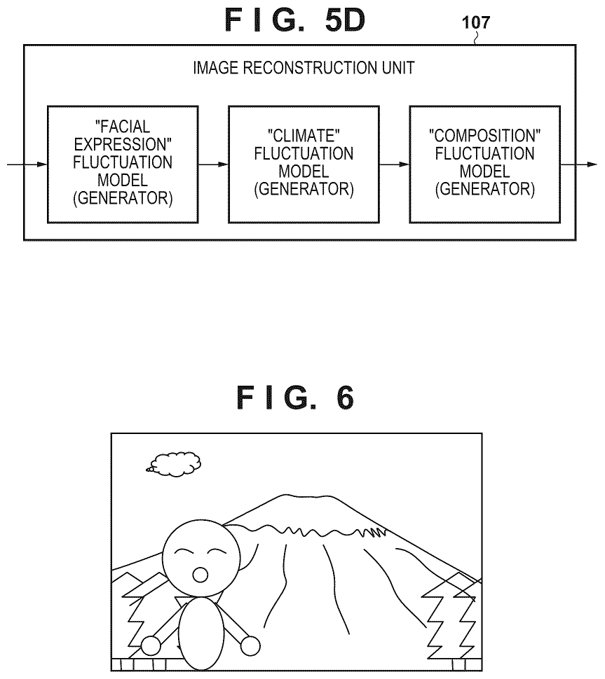

Here, a method for creating fluctuation rules according to the present embodiment will be described with reference to FIGS. 5A to 5D. FIGS. 5A to 5D show the relationship between the degree of fluctuation of a fluctuation element of the image targeted for reconstruction and various information.

The fluctuation rule determination unit 106 selects and reads out fluctuation model information related to the fluctuation element of the image 208 targeted for reconstruction from the fluctuation model database 104. Note that the fluctuation model information that is read out is information of a fluctuation model trained using learning data, and the learning data includes at least the image including the fluctuation element targeted for reconstruction.

The fluctuation rule determination unit 106 calculates information of a fluctuation range that is reconstructable in the fluctuation model, using the read fluctuation model information and the related learning data group. For example, an example distribution of learning data of a fluctuation model relating to smiliness is shown in FIG. 5A. In the training of GANs described above, the GANs are trained to be able to generate an image of the degree of fluctuation included in the learning data. Accordingly, it is understood from the distribution of the degree of smiliness in the learning data shown in FIG. 5A that the fluctuation range of images that are reconstructable by designating the degree of the fluctuation element is in a range of degrees of fluctuation 1 to 6.

Next, the fluctuation rule determination unit 106 calculates, from the shooting intention identifier, a recommended value of the degree of fluctuation of the fluctuation element after reconstruction. In the present embodiment, for example, the digital camera 100 holds information associating the aforementioned shooting intention identifiers with ideal degrees of fluctuation of the fluctuation elements in advance as conversion table information of the shooting intention and the ideal degree of fluctuation. The fluctuation rule determination unit 106 calculates the degree of fluctuation of the fluctuation element after reconstruction, by referring to the conversion table information.

For example, in the conversion table for the shooting intention identifier “fun”, the fluctuation elements “facial expression” and “composition” are associated, as shown in FIG. 5B. In this example, the ideal degree of fluctuation of the fluctuation element “facial expression” is associated such that the degree of smiliness of “facial expression” is a degree of fluctuation of 7, which is the maximum value.

The fluctuation rule determination unit 106 determines the fluctuation model to be utilized and calculates parameter to be set in the determined fluctuation model. The parameter to be set is calculated so as to fall within the aforementioned reconstructable fluctuation range, and approach the ideal degree of fluctuation of the fluctuation element according to the shooting intention.

For example, first, the fluctuation rule determination unit 106 determines whether the ideal degree of fluctuation corresponding to the shooting intention corresponds to a degree of fluctuation that is settable for reconstruction among the degrees of fluctuation (in the above example, between degrees of fluctuation 1 and 6). When the ideal degree of fluctuation corresponds to a degree of fluctuation settable for reconstruction among the degrees of fluctuation, the fluctuation rule determination unit 106 sets the ideal degree of fluctuation as the degree of fluctuation set for reconstruction. When the ideal degree of fluctuation does not correspond to a degree of fluctuation settable for reconstruction among the degrees of fluctuation, the fluctuation rule determination unit 106 sets the degree of fluctuation that is closest to the ideal degree of fluctuation, among the degrees of fluctuation settable for reconstruction, as the degree of fluctuation set for reconstruction. That is, the adjusted degree of fluctuation that has been adjusted according to the ideal degree of fluctuation is set for reconstruction. For example, the parameter that is set in the fluctuation model of the fluctuation element “facial expression” as the ideal degree of fluctuation is the degree of fluctuation 7, as shown in FIG. 5B, whereas, the upper limit of the reconstructable range of the fluctuation model is the degree of fluctuation 6, as shown in FIG. 5A. Thus, the value that is set is the degree of fluctuation 6, as shown in FIG. 5C.

Furthermore, the fluctuation rule determination unit 106 determines the order of reconstruction processing that uses a plurality of fluctuation models. The processing order of the fluctuation models referred to here is not particularly limited and may be determined by various factors. In the present embodiment, for example, the fluctuation models are processed in order from the fluctuation model with the largest difference between the aforementioned recommended value of the degree of fluctuation and the degree of fluctuation in the image targeted for reconstruction to the fluctuation model with the smallest difference. In this case, for example, as shown in FIG. 5D, fluctuation model reconstruction processing is implemented in the order of “facial expression” first, “sunniness” next, and “composition” last.

The fluctuation rule determination unit 106, in this way, outputs fluctuation model information, parameter information to be passed to the fluctuation models, and reconstruction processing order information of the fluctuation models to the image reconstruction unit 107 as a fluctuation rule.

Returning to FIG. 4, in step S405, the image reconstruction unit 107 executes reconstruction processing, using the image targeted for reconstruction and the fluctuation rule determined by the fluctuation rule determination unit 106. For example, as a result of the reconstruction processing, an image such as shown in FIG. 6 is generated. The reconstructed image shown in FIG. 6 is a new image in which the “composition” has not changed greatly, the degree of smiliness of the “facial expression” is large, and the degree of “sunniness” is large (few clouds) while maintaining the atmosphere of the image 208 targeted for reconstruction.

Note that a configuration may be adopted in which the generated image prompts confirmation by the user, via the display control unit 108, and receive feedback on the reconstruction processing. For example, the reconstruction processing may be newly implemented along with the recording processing, by applying positive feedback to the fluctuation model, if a recording instruction to record the reconstructed image is issued by the user, and by applying negative feedback if this is not the case.

Due to the above processing, the degree of fluctuation of the fluctuation element of the acquired image and information indicating the shooting intention of the user are acquired, and images with different degrees of fluctuation are generated from the acquired image, using the trained learning model. At this time, the learning model generates an image in which the degree of fluctuation acquired in the acquired image is set as the degree corresponding to the information indicating the shooting intention. By adopting such a configuration, it becomes possible to obtain an image in which the shooting intention is more appropriately reflected.

### Image Generation and Display Processing

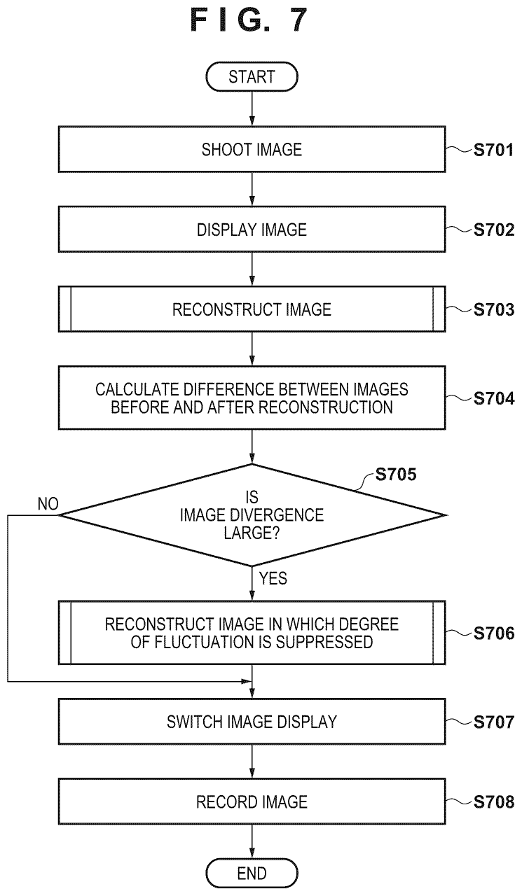

Next, post-shooting image generation and display processing in the present embodiment in the case of implementing image reconstruction will be described, with reference to FIG. 7. The digital camera 100 in the present embodiment shoots an image with the image capturing device 129 upon receiving an image acquisition instruction by the user from the input device 127. When reconstruction of the acquired image is not implemented, the post-shooting display processing is ended after displaying the image acquired by the image capturing device 129 is displayed on the display device 128 for a certain period. On the other hand, when reconstruction of the acquired image is implemented, the processing shown in FIG. 7 is started upon receiving an image acquisition instruction from the user.

In step S701, the image acquisition unit 101 controls the image capturing device 129 to shoot an image, upon receiving an image acquisition instruction from the user.

In step S702, the display control unit 108 causes the display device 128 to display the image acquired by the image acquisition unit 101.

In step S703, the display control unit 108 implements reconstruction processing on the image acquired by the image acquisition unit 101 as aforementioned with reference to FIG. 4.

In step S704, the image difference calculation unit 110 compares the image before reconstruction acquired by the image acquisition unit 101 with the image after reconstruction generated by the image reconstruction unit 107, and calculates the difference between the images before and after reconstruction.

As a method for calculating the difference between images by the image difference calculation unit 110, the difference in the degree of fluctuation may, for example, be calculated for each fluctuation element included in an image, and output as a difference result linked with the difference between the fluctuation element and the degree of fluctuation. For example, in FIG. 5C, the degree of fluctuation of the fluctuation element “smiliness” in the image targeted for reconstruction is 2, and the degree of fluctuation in the image after reconstruction is 6, and thus 4 is output as the difference result related to “smiliness”. In a similar calculation method, for example, 2 is output as the difference result related to “eye openness”, and 5 is output as the difference result of “mouth openness”.

Also, output of the difference result may be achieved, by normalizing the degree of fluctuation of all the fluctuation elements included in the image and calculating the total value or average value of the differences in the degrees of fluctuation. Furthermore, weighting may be implemented on the difference in the degree of fluctuation, depending on the degree of influence on the image at the time of implementing reconstruction, due to the change in the degree of fluctuation. For example, in the reconstruction of an image relating to “facial expression”, even if the degree of fluctuation changed greatly, only the face of the main subject and the surroundings thereof change, and thus the difference between the images before and after reconstruction is small. On the other hand, in the reconstruction of an image relating to “composition”, the position of the subject within the image changes even with a small change in the degree of fluctuation, and thus the difference between the images before and after reconstruction tends to be large. Accordingly, even if the difference in the degree of fluctuation relating to “composition” is small, the weight is set so that the difference result is high.

Note that the method of calculating the difference between images is not limited to the method described above, and, for example, the image difference calculation unit 110 may calculate difference information by determining the composition of the image before and after reconstruction and the amount of movement of the subject using an interframe difference method.

In step S705, the image difference calculation unit 110 further determines whether the image acquired by the image acquisition unit 101 and the image generated by the image reconstruction unit 107 diverge by greater than or equal to a predetermined divergence, based on the difference information calculated in step S704. If it is determined that the images before and after reconstruction diverge by greater than or equal to the predetermined divergence, the image reconstruction unit 107 and the display control unit 108 are notified, and the processing proceeds to step S706. If it is determined that the images before and after reconstruction diverge by less than the predetermined divergence, the processing proceeds to step S707.

Here, for example, when the difference in the degree of fluctuation is calculated for each fluctuation element in step S704, a threshold value is set for the fluctuation element, and if any one of the calculated differences in the degree of fluctuation exceeds the threshold value, it is determined that the divergence is greater than or equal to the predetermined divergence. The threshold value of the degree of fluctuation for each fluctuation element is determined in advance, for each fluctuation element, with consideration for the amount of difference in the degree of fluctuation between the images. For example, the threshold value for “facial expression” is set high, and the threshold value for “composition” is set low. Alternatively, the threshold value may be determined at the timing of the shooting action, by linking to the user's behavior history before and after the shooting action.

Also, when calculating the difference between images with the interframe difference method, it may be determined that the divergence is greater than or equal to a predetermined divergence, when the difference between the images is greater than or equal to a specific percentage of the frame area, for example.

In step S706, the image reconstruction unit 107 implements image reconstruction, upon receiving notification from the image difference calculation unit 110. Here, with similar processing to the image reconstruction processing in step S703, the image reconstruction unit 107 generates a new image in which the degree of fluctuation is less than the image generated in step S703.

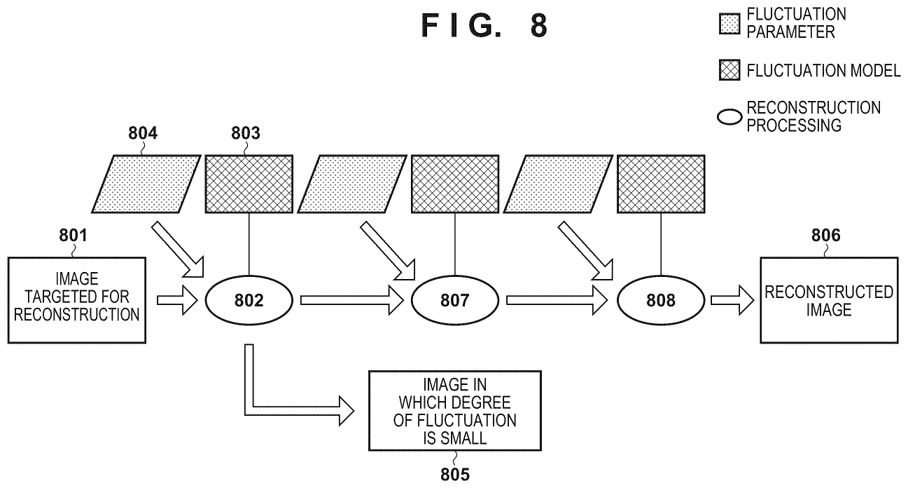

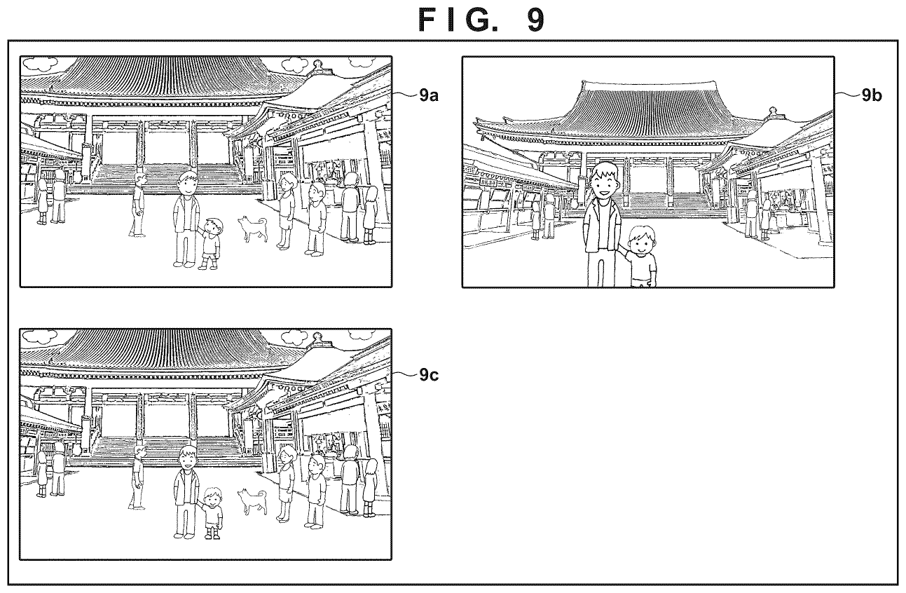

Here, the divergence between the images before and after reconstruction generated in step S703 and the procedure performed in step S706 in which the image reconstruction unit 107 generates an image in which the degree of fluctuation is suppressed will be described with reference to FIGS. 8 and 9. FIG. 8 shows the flow of processing for reconstructing an image targeted for reconstruction, based on the order of reconstruction processing determined by the fluctuation rule determination unit 106, and FIG. 9 shows an example of an image targeted for reconstruction and images generated by the reconstruction processing.

An image 801 is an image targeted for reconstruction. Here, for example, an image 9a shown in FIG. 9 is the image 801 targeted for reconstruction.

In reconstruction processing 802, reconstruction using a fluctuation model 803 is implemented on the image 801, by passing a fluctuation parameter 804 to the fluctuation model 803. An image 805 is then generated, as a result of the reconstruction processing. For example, when the fluctuation model 803 is “facial expression”, an image 9b is generated by reconstructing the “facial expression” in the image 9a.

The image reconstruction unit 107 reconstructs the image by implementing all of the reconstruction processing, based on the order of reconstruction processing determined by the fluctuation rule determination unit 106. As a result, a reconstructed image 806 is generated. For example, by implementing reconstruction processing 807 and reconstruction processing 808 on the image 9b generated by the reconstruction processing 802, a reconstruction result such as shown in an image 9c can be acquired.

Images 9b and 9c are both output results obtained by reconstructing image 9a using a fluctuation model. However, the image 9b is an image in which only the “facial expression” is reconstructed, whereas the image 9c is an image in which other fluctuation elements that were not implemented in the reconstruction processing 802, such as the “composition” and “climate” of the photograph, are reconstructed. In step S703, the image 9c in which all of the fluctuation elements are reconstructed is output.

On the other hand, the difference of the image 9c from the image 9a is large due particularly to reconstruction of the “composition”, whereas the difference of the image 9b from the image 9a is small, since reconstruction of the “composition” is not implemented. In this way, the image reconstruction unit 107 is capable of generating an image in which the degree of fluctuation is suppressed by reducing the number of fluctuation models used and the amount of reconstruction processing. In step S706, the image 9b reconstructed for some fluctuation elements is output.

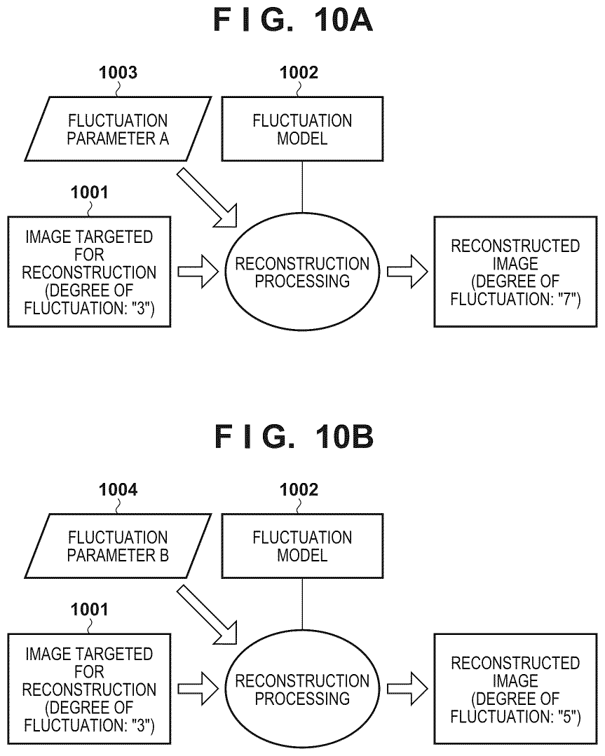

Note that, as a method for generating an image in which the degree of fluctuation is suppressed, the parameter information that is passed to the fluctuation model may be changed. Hereinafter, the concept of an image generation method in the case of changing parameter information will be described with reference to FIGS. 10A and 10B.

In FIGS. 10A and 10B, reconstruction processing is implemented on a targeted image 1001, using the same fluctuation model 1002. In FIG. 10A, reconstruction processing is implemented by passing a fluctuation parameter A1003 to the fluctuation model 1002. As a result, an image in which the degree of fluctuation of the targeted image is changed from “3” to “7” can be acquired. In step S703, an image reconstructed using the fluctuation parameter A1003 in which the degree of fluctuation is high in this way is output.

On the other hand, in FIG. 10B, reconstruction processing is implemented by passing a fluctuation parameter B1004 to the fluctuation model 1002. As a result, an image in which the degree of fluctuation of the targeted image is changed from “3” to “5” can be acquired. In this way, by changing the parameter information, it is possible to generate an image in which the degree of fluctuation is suppressed. In step S706, an image reconstructed using the fluctuation parameter B1004 in which the degree of fluctuation is suppressed in this way is output.

In step S706, an image in which the degree of fluctuation is suppressed is generated by the above processing, and output to the display control unit 108.

In step S707, the display control unit 108 switches the image displayed on the display device 128 from the image acquired by the image acquisition unit 101 to the image generated by the image reconstruction unit 107. Note that if notification from the image difference calculation unit 110 is being received, an image that is the output result of step S706 is displayed, and if notification is not being received, an image that is the output result of step S703 is displayed.

For example, when display is switched from the image 9a before reconstruction shown in FIG. 9 to the image 9c which is the reconstruction result, the difference between the images due to the “composition” within the image being reconstructed is large, and thus the user is likely to feel a sense of incongruity when display of the images is switched. On the other hand, when the display is switched from the image 9a to the image 9b in which the degree of fluctuation is suppressed, the difference between the images is small, and thus the user is less likely to feel a sense of incongruity, and, furthermore, the reconstruction effects of specific fluctuation elements, such as the “facial expression” of the subject, become visually recognizable.

In step S708, the recording unit 111 records the image generated by the image reconstruction unit 107 in step S703 to the HDD 125, regardless of the determination result of the image difference calculation unit 110.

According to the first embodiment as described above, when the degree of divergence between the images before and after reconstruction is greater than or equal to a predetermined divergence, an image in which the degree of fluctuation is suppressed is newly reconstructed and displayed. By adopting such a configuration, it becomes possible, in the case of reconstructing an image, to reduce the sense of incongruity felt at the time of preview display.

### Second Embodiment

Next, a second embodiment of the present invention will be described. Note that since an image processing apparatus in the present embodiment has a similar configuration to the image processing apparatus described with reference to FIG. 1 in the first embodiment, description thereof is omitted here.

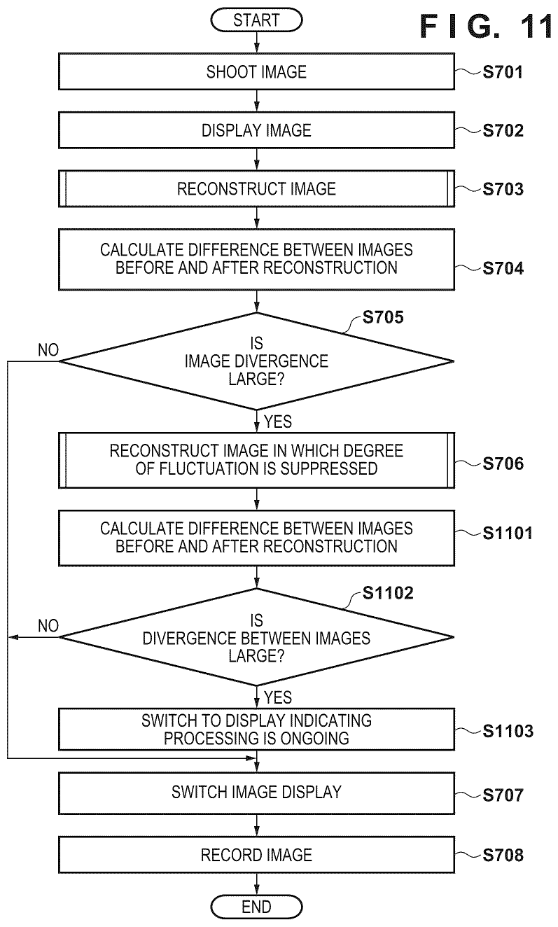

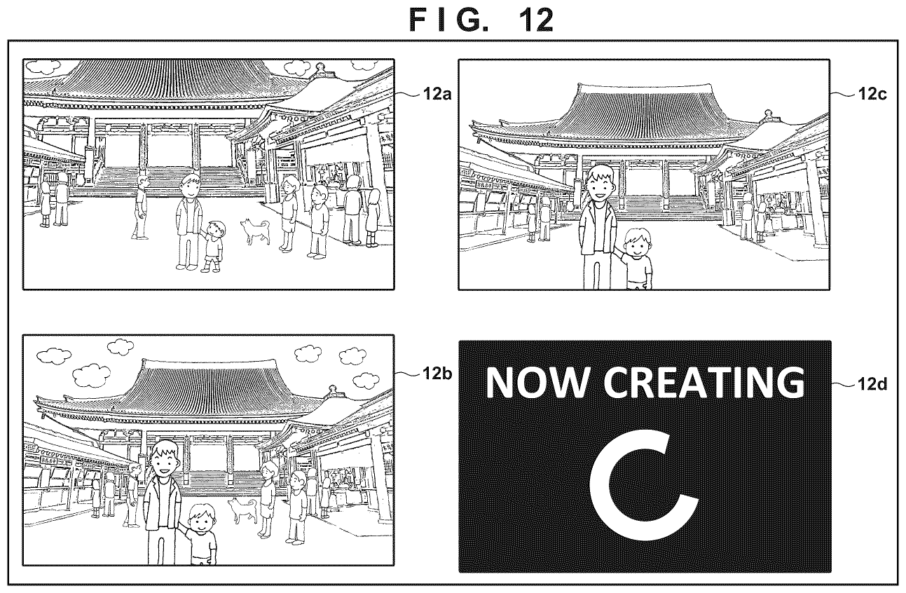

FIG. 11 is a flowchart showing post-shooting image display and recording control of an image in the case of implementing image reconstruction in the present embodiment. Note that, in FIG. 11, similar processing to the control shown in FIG. 7 in the first embodiment is given the same reference numbers and description thereof is omitted.

In step S706, when reconstruction of an image in which the degree of fluctuation is suppressed is completed, the image difference calculation unit 110, in step S1101, calculates the difference between the image acquired by the image acquisition unit 101 and the image generated by the image reconstruction unit 107 in step S706.

In step S1102, the image difference calculation unit 110 further determines whether the image acquired by the image acquisition unit 101 and the image generated by the image reconstruction unit 107 in step S706 diverge by greater than or equal to a predetermined divergence, based on difference information between the images before and after reconstruction calculated in step S1101. If it is determined that the images before and after reconstruction diverge by greater than or equal to the predetermined divergence, the display control unit 108 is notified, and the processing proceeds to step S1103. If it is determined that the images before and after reconstruction diverge by less than the predetermined divergence, the processing proceeds to step S707. Note that the predetermined divergence referred to here may be the same threshold value as step S705 or may be a different threshold value.

In step S1103, the display control unit 108 switches the image displayed on the display device 128 from the image acquired by the image acquisition unit 101 to an arbitrary image.

Here, the arbitrary image is, for example, an image having a predetermined color such as black, or an image 12d indicating that processing is in progress such as shown in FIG. 12. Note that an example is shown in which the image 12a is the image targeted for reconstruction acquired in step S701, an image 12c is the image reconstructed in S703, and an image 12b is the image reconstructed in step S706. In step S707, the image 12d is used for reducing the sense of incongruity felt when switching the image displayed on the display device 128 from the image 12a to the image 12b. The image 12d may be any image that does not depart from that use application.

According to the second embodiment as described above, when the degree of divergence between the images before and after reconstruction is greater than or equal to a divergence determined in advance, with regard to a newly generated image in which the degree of fluctuation is suppressed, an arbitrary image is displayed before displaying an image reconstructed for all fluctuation elements. By adopting such a configuration, it becomes possible, in the case of reconstructing an image, to reduce the sense of incongruity felt at the time of preview display.

### Third Embodiment

Next, a third embodiment of the present invention will be described. Note that since an image processing apparatus in the present embodiment also has a similar configuration to the image processing apparatus described with reference to FIG. 1 in the first embodiment, description thereof is omitted here.

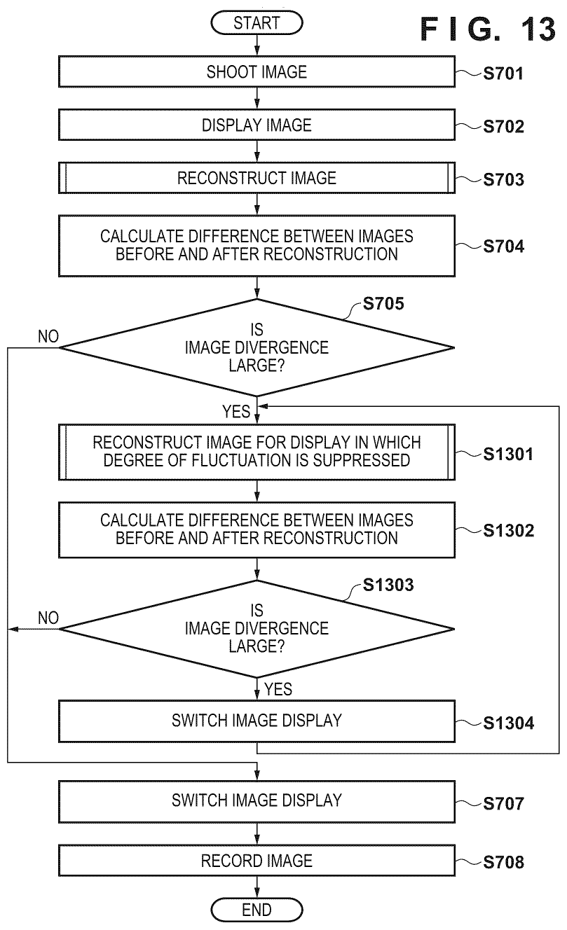

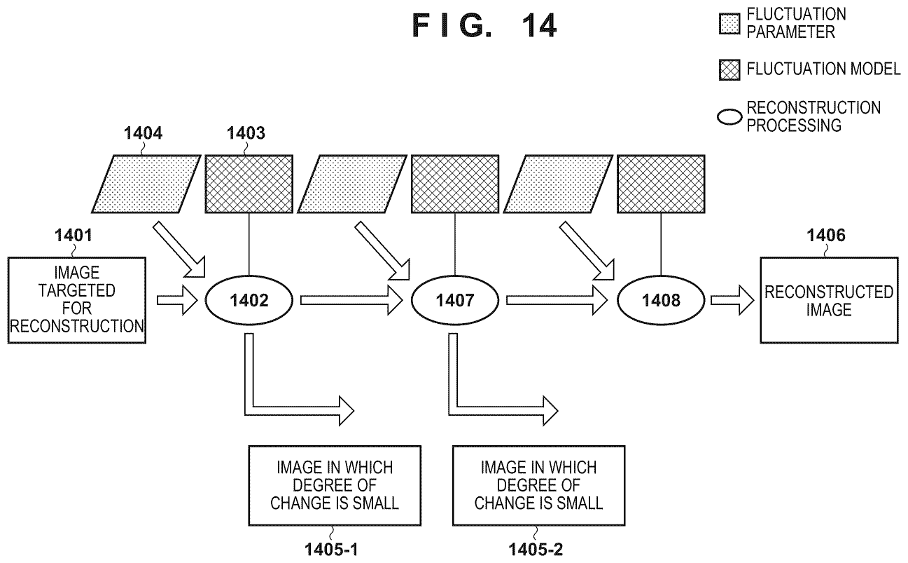

FIG. 13 is a flowchart showing post-shooting image display and recording control of an image in the case of implementing image reconstruction in the present embodiment. Note that, in FIG. 13, similar processing to the control shown in FIG. 7 in the first embodiment is given the same reference numbers and description thereof is omitted.

In step S705, if it is determined that the image acquired by the image acquisition unit 101 in step S701 and the image generated by the image reconstruction unit 107 in step S703 diverge by greater than or equal to a predetermined divergence, the image reconstruction unit 107 and the display control unit 108 are notified, and the processing proceeds to step S1301. If it is determined that the images before and after reconstruction diverge by less than the predetermined divergence, the processing proceeds to step S707.

In step S1301, the image reconstruction unit 107 implements image reconstruction upon receiving notification from the image difference calculation unit 110. Here, with similar processing to the image reconstruction processing in step S703, the image reconstruction unit 107 generates a new image in which the degree of fluctuation is less than the image generated in step S703.

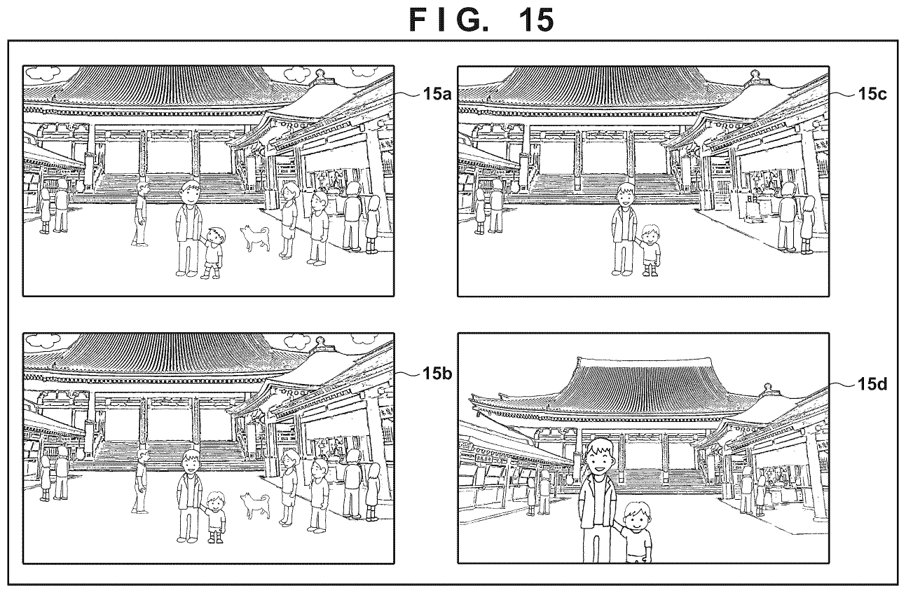

Here, the divergence between the images before and after reconstruction generated in step S703 and the procedure performed in step S1301 in which the image reconstruction unit 107 generates an image in which the degree of fluctuation is suppressed will be described with reference to FIGS. 14 and 15. FIG. 14 shows the flow of processing for reconstructing an image targeted for reconstruction, based on the order of reconstruction processing determined by the fluctuation rule determination unit 106, and FIG. 15 shows an example of an image targeted for reconstruction and an image generated by the reconstruction processing.

An image 1401 is an image targeted for reconstruction. Here, for example, an image 15a shown in FIG. 15 is the image 1401 targeted for reconstruction.

In reconstruction processing 1402, reconstruction using a fluctuation model 1403 is implemented on the image 1401, by passing a fluctuation parameter 1404 to the fluctuation model 1403. An image 1405(1) is then generated, as a result of the reconstruction processing. For example, when the fluctuation model 1403 is “facial expression”, an image 15b is generated by performing reconstruction of the “facial expression” of the image 15a.

The image reconstruction unit 107 reconstructs the image by implementing all of the reconstruction processing, based on the order of the reconstruction processing determined by the fluctuation rule determination unit 106. As a result, a reconstructed image 1406 is generated. For example, by implementing reconstruction processing 1407 on the image 15b generated by the reconstruction processing 1402, an image 1405(2) is generated, and an image 15c which is the reconstruction result can be acquired. Similarly, by implementing reconstruction processing 1408 on the image 15c generated by the reconstruction processing 1407, an image 1406 is generated, and an image 15d which is the reconstruction result can be acquired.

Note that the fluctuation rule determination unit 106 may determine the order of the reconstruction processing for each fluctuation element as shown in FIG. 15, or may determine the order for each arbitrary region. Alternatively, the order may be determined such that the fluctuation elements or the arbitrary regions are in order of close range to long range or in order of long range to close range, or alternatively, in ascending order of difference between the images or in descending order of difference between the images.

In step S1302, the image difference calculation unit 110 compares the image generated by the image reconstruction unit 107 in step S703 with the image generated by the image reconstruction unit 107 in step S1301, and calculates the difference between the images before and after reconstruction.

In step S1303, furthermore, the image difference calculation unit 110 determines whether the image generated by the image reconstruction unit 107 in step S703 and the image generated by the image reconstruction unit 107 in step S1302 diverges by greater than or equal to a predetermined divergence, based on the difference information between the images before and after reconstruction calculated in step S1302. If it is determined that the images before and after reconstruction diverge by greater than or equal to the predetermined divergence, the processing proceeds to step S1305. If it is determined that the images before and after reconstruction diverge by less than the predetermined divergence, the display control unit 108 is notified, and the processing proceeds to step S707.

In step S1304, the display control unit 108 switches the image displayed on the display device 128 to the image generated by the image reconstruction unit 107 in step S1301 and returns to step S1301. Images in which the degree of fluctuation is gradually increased are thereby generated and displayed, until the divergence between the image generated by the image reconstruction unit 107 in step S703 and the image generated by the image reconstruction unit 107 in step S1302 becomes smaller than the prescribed divergence.

According to the third embodiment as described above, images in which fluctuation in the images before and after reconstruction differ are newly generated and displayed, according to the degree of divergence between the images before and after reconstruction. By adopting such a configuration, it becomes possible, in the case of generating reconstructed images, to reduce the sense of incongruity felt at the time of preview display.

Note that, in the first to third embodiments described above, a digital camera capable of generating images was described as an example of the image processing apparatus. However, the present invention is not limited to devices capable of generating images and can be applied to devices capable of inputting images from an external device. For example, reconstruction processing may be performed on images acquired by connecting the device to a camera or on images saved on a server or a cloud that are acquired via a network. In such cases, a configuration may be adopted in which the above-described processing shown in FIGS. 7, 11, and 13 is started in response to a shooting instruction in an external device or an image input instruction from an external device.

According to the present invention, in the case of generating reconstructed images, the sense of incongruity felt at the time of preview display of the reconstructed images can be reduced.

### OTHER EMBODIMENTS

Note that the present invention may be applied to a system constituted by a plurality of devices or to an apparatus consisting of one device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising one or more processors and/or circuitry which function as:
an image acquisition unit that acquires a first image;
a degree-of-fluctuation acquisition unit that acquires a degree of fluctuation of a fluctuation element having fluctuation which is variation in a state, among elements constituting the first image;
a generation unit that uses the first image to generate a second image in which the degree of fluctuation of the fluctuation element is different from the first image with use of a trained learning model; and
a display control unit that controls to display an image on a display device,
wherein, in a case where the first image and the second image diverge by greater than or equal to a predetermined divergence, the generation unit further uses the first image to generate a third image in which the degree of fluctuation of the fluctuation element is less than the second image, and
the display control unit performs control to display the first image and to thereafter display the third image.

2. The image processing apparatus according to claim 1,
wherein, in a case where the first image and the third image diverge by greater than or equal to a predetermined divergence, the display control unit performs control to display the first image, to thereafter display an arbitrary image different from the first image, the second image, and the third image, and to display the third image after displaying the arbitrary image.

3. The image processing apparatus according to claim 2,
wherein the arbitrary image includes at least one of an image having a predetermined color and an image indicating that processing by the generation unit is in progress.

4. The image processing apparatus according to claim 1,
wherein, in a case where the second image and the third image diverge by greater than or equal to a predetermined divergence, the generation unti further uses the first image to increase the degree of fluctuation of the fluctuation element, and to again generate a third image in which the degree of fluctuation of the fluctuation element is less than the second image, and
the display control unit performs control to display the first image and to thereafter display the third images in order of generation.

5. The image processing apparatus according to claim 4,
wherein the generation unit
generates the second image by performing reconstruction processing using a plurality of fluctuation models as the learning model, and
generates the third image by performing reconstruction processing, for each of the fluctuation elements or for each of predetermined regions.

6. The image processing apparatus according to claim 5,
wherein the generation unit generates the third image by performing the reconstruction processing on the fluctuation elements or the predetermined regions in order from close range to long range or from long range to close range.

7. The image processing apparatus according to claim 5,
wherein the generation unit generates the third image by performing the reconstruction processing on the fluctuation elements or the predetermined regions in ascending order of divergence or in descending order of divergence between the first image and the second image.

8. The image processing apparatus according to claim 1, wherein the one or more processors and/or circuitry further function as:
a recording unit that records an image to a recording medium,
wherein the recording unit records the second image and does not record the third image.

9. The image processing apparatus according to claim 1, wherein the one or more processors and/or circuitry further function as:
a determination unit that determines a state of divergence between images, based on a difference in the degree of fluctuation of the same fluctuation element between the images.

10. The image processing apparatus according to claim 1, wherein the one or more processors and/or circuitry further function as:
a determination unit that determines a state of divergence between images by an interframe difference method.

11. The image processing apparatus according to claim 1,
wherein the generation unit
generates the second image by performing reconstruction processing, using a plurality of fluctuation models as the learning model, and
generates the third image by reducing the number of fluctuation models that are used, among the plurality of fluctuation models.

12. The image processing apparatus according to claim 1,
wherein the generation unit
generates the second image by performing reconstruction processing, using a plurality of fluctuation models as the learning model, and
generates the third image by changing a parameter indicating the degree of fluctuation given to the fluctuation model.

13. The image processing apparatus according to claim 1,
wherein the display control unit performs display in response to acquisition of the first image, and
the generation unit generates the second image in response to acquisition of the first image.

14. An image processing method comprising:
acquiring a first image;
acquiring a degree of fluctuation of a fluctuation element having fluctuation which is variation in a state, among elements constituting the first image;
using the first image to generate a second image in which the degree of fluctuation of the fluctuation element is different from the first image with use of a trained learning model; and
in a case where the first image and the second image diverge by greater than or equal to a predetermined divergence, using the first image to generate a third image in which the degree of fluctuation of the fluctuation element is less than the second image; and
in a case where the first image and the second image diverge by greater than or equal to the predetermined divergence, performing control to display the first image and to thereafter display the third image on a display device.

15. A non-transitory computer-readable storage medium, the storage medium storing a program that is executable by the computer, wherein the program includes program code for causing the computer to function as an image processing apparatus comprising:
an image acquisition unit that acquires a first image;
a degree-of-fluctuation acquisition unit that acquires a degree of fluctuation of a fluctuation element having fluctuation which is variation in a state, among elements constituting the first image;
a generation unit that uses the first image to generate a second image in which the degree of fluctuation of the fluctuation element is different from the first image with use of a trained learning model; and
a display control unit that controls to display an image on a display device,
wherein, in a case where the first image and the second image diverge by greater than or equal to a predetermined divergence, the generation unit further uses the first image to generate a third image in which the degree of fluctuation of the fluctuation element is less than the second image, and
the display control unit performs control to display the first image and to thereafter display the third image.
